(19) United States
(12) Patent Application Publication
(10) Pub. No.: US 2022/0063021 A1
(43) Pub. Date: Mar. 3, 2022

(54) ROBOTIC LASER-GUIDE DEVICE FOR LASER SHOCK PEENING

(71) Applicant: GUANGDONG LASER PEENING TECHNOLOGY CO., LTD., Foshan (CN)

(72) Inventors: Yongkang ZHANG, Foshan (CN); Chaohui LIN, Foshan (CN); Xiaojun GUO, Foshan (CN); Chao YANG, Foshan (CN); Jianxin LIU, Foshan (CN); Xiaoming SHAN, Foshan (CN)

(21) Appl. No.: 17/523,039

(22) Filed: Nov. 10, 2021

Related U.S. Application Data
(63) Continuation of application No. PCT/CN2020/082791, filed on Apr. 1, 2020.

(30) Foreign Application Priority Data
May 16, 2019 (CN) 201910404585.6

(51) Int. Cl. B23K 26/356; B25J 19/00; B23K 26/06; B23K 26/08

(52) U.S. Cl. CPC B23K 26/356; B25J 19/0037; B23K 26/0665; B25J 11/005; B23K 26/0643; B23K 26/0648; B23K 26/0884

(57) ABSTRACT

A robotic laser-guiding device for laser shock peening includes a laser-guiding arm, a reflecting mirror and a manipulator. The laser-guiding arm includes a laser entry tube, a laser-guiding tube, a laser exit tube and a laser shock head sequentially connected. The laser entry tube is rotatably connected to the laser-guiding tube through a joint. The laser-guiding tube is rotatably connected to the laser exit tube through a joint. The laser entry tube is connected to a laser generator. Each joint is provided with the reflecting mirror. The laser emitted by the laser generator passes through the laser entry tube, one reflecting mirror, the laser-guiding tube, another reflecting mirror, the laser exit tube and the laser shock head to irradiate a part, so as to perform the laser shock peening.

### CROSS-REFERENCE TO RELATED APPLICATIONS

This application is a continuation of International Patent Application No. PCT/CN2020/082791, filed on Apr. 1, 2020, which claims the benefit of priority from Chinese Patent Application No. 201910404585.6 filed on May 16, 2019. The content of the aforementioned applications, including any intervening amendments thereto, is incorporated herein by reference in its entirety.

### TECHNICAL FIELD

This application relates to laser shock peening (LSP) technology, and more particularly to a robotic laser-guide device for laser shock peening.

### BACKGROUND

In the laser shock peening (LSP) process, the high-energy laser beam emitted by the laser travels in a straight line, and the emission direction of the laser cannot be flexibly controlled, which limit the application of the laser shock peening. In the practical operation, a small part may be controlled by a robot such that the emitted laser exactly focuses on the point of the part needed to be peened. However, as for a large part, the robot fails to control its position. In addition, as for a structurally-complex part, the laser cannot reach the target position in a straight line due to the blockage of other parts.

### SUMMARY

In view of the above-mentioned problems in the prior art, an objective of the present disclosure is to provide a robotic laser-guide device for laser shock peening, which is capable of changing a travelling direction of the laser.

The technical solutions of the present disclosure are described as follows.

The disclosure provides a robotic laser-guide device for laser shock peening, comprising:
a laser-guiding arm;
a first reflecting mirror;
a second reflecting mirror; and
a manipulator;
wherein the laser-guiding arm comprises a laser entry tube, a laser-guiding tube, a laser exit tube and a laser shock head; the laser entry tube, the laser-guiding tube, the laser exit tube and the laser shock head are sequentially connected; the laser-guiding arm also comprises a first joint and a second joint; the laser entry tube is rotatably connected to the laser-guiding tube through the first joint; the laser-guiding tube is rotatably connected to the laser exit tube through the second joint; and the laser entry tube is connected to a laser generator;
the first reflecting mirror is provided in the first joint; the second reflecting mirror is provided in the second joint; the first reflecting mirror and the second reflecting mirror are configured to adjust a direction of laser; the laser emitted by the laser generator is configured to pass through the laser entry tube, the first reflecting mirror, the laser-guiding tube, the second reflecting mirror, the laser exit tube and the laser shock head to irradiate a part to be processed, so as to perform laser peening on the part to be processed; and the laser shock head is configured to focus the laser; and
the manipulator is connected to the laser-guiding tube; the manipulator is configured to drive the laser-guiding tube to move with respect to the part to be processed under a rotation of the first joint and the second joint, so as to drive the laser shock head to move with respect to the part to be processed through the laser exit tube to adjust an angle between the laser shock head and the part to be processed and/or a position of the laser shock head with respect to the part to be processed.

In some embodiments, the laser-guiding tube comprises a first laser-guiding tube, a second laser-guiding tube and a third laser-guiding tube; the first laser-guiding tube, the second laser-guiding tube and the third laser-guiding tube are sequentially connected; the laser entry tube is connected to an end of the first laser-guiding tube away from the second laser-guiding tube; the third laser-guiding tube is connected to an end of the laser exit tube away from the laser shock head; the laser entry tube is rotatably connected to the first laser-guiding tube through the first joint; the first laser-guiding tube is rotatably connected to the second laser-guiding tube through a third joint; the second laser-guiding tube is rotatably connected to the third laser-guiding tube through a fourth joint; the third laser-guiding tube is rotatably connected to the laser exit tube through the second joint; a third reflecting mirror is provided in the third joint; a fourth reflecting mirror is provided in the fourth joint; the manipulator is connected to the third laser-guiding tube; the manipulator is configured to drive the third laser-guiding tube to move with respect to the part to be processed under rotation of the first joint, the second joint, the third joint and the fourth joint, so as to drive the laser shock head to move with respect to the part to be processed through the laser exit tube to adjust the angle the laser shock head and the part to be processed and/or the position of the laser shock head with respect to the part to be processed.

In some embodiments, the laser-guiding tube further comprises a connecting tube; the connecting tube is arranged between the second laser-guiding tube and the third laser-guiding tube, and is connected to the second laser-guiding tube through the fourth joint.

In some embodiments, the first joint, the second joint, the third joint and the fourth joint each comprises a first connecting part and a second connecting part; the first connecting part and the second connecting part are perpendicularly connected; and the first connecting part and the second connecting part are respectively connected to two components that are connected through one of the first joint, the second joint, the third joint and the fourth joint.

In some embodiments, an angle between each reflecting mirror and the laser irradiated thereon is 45°, such that after reflected by each reflecting mirror, a travelling direction of the laser is changed by 90° at each joint.

In some embodiments, the first joint comprises a plurality of first joints; the third joint comprises a plurality of third joints; the fourth joint comprises a plurality of fourth joints; two adjacent first joints are rotatably connected to each other; two adjacent third joints are rotatably connected to each other; and two adjacent fourth joints are rotatably connected to each other.

In some embodiments, the number of the plurality of first joints is two; the number of the plurality of fourth joints is two; and the number of the third joints is three.

In some embodiments, the laser generator is provided with an output port; the laser generator is configured to output the laser through the output port; the laser entry tube is connected to the output port of the laser generator; and the laser entry tube and the output port are coaxially arranged.

In some embodiments, the laser shock head is detachably connected to the laser exit tube.

In some embodiments, the laser shock head comprises a shell, a convex lens and a fully-transparent plane mirror; the shell is hollow; two ends of the shell are open; a first open end of the shell is connected to the laser exit tube; a second open end of the shell is provided with the fully-transparent plane mirror; the convex lens is arranged in the shell; the convex lens is configured to focus the laser; the fully-transparent plane mirror is configured to block an external interference object from contacting the convex lens; the laser output through the laser exit tube is capable of passing through the first open end of the shell to enter the shell and sequentially passing through the convex lens, the fully-transparent plane mirror and the second open end of the shell to be transmitted to an outside of the shell.

The beneficial effects of the present disclosure are described as follows.

When the robotic laser-guiding device of the disclosure is used for laser shock peening, a manipulator drives a laser-guiding tube to move with respect to the part to be processed under the rotation of multiple joints, so as to allow a laser exit tube to drive a laser shock head to move with respect to the part, such that an angle and/or a position of the laser shock head with respect to the part can be adjusted. The laser-shooting head aims at a position on the part needed to be peened, and then a laser is emitted by a laser generator, and then passes through a laser entry tube, a reflecting mirror, a laser-guiding tube, another reflecting mirror, a laser exit tube and the laser shock head to irradiate the position need to be peened, so as to perform the laser peening on the part. When the manipulator drives the laser-guiding tube to move, the manipulator can simultaneously drive the laser entry tube to move through the joint, which indicates that a relative rotation can occur between the laser-guiding tube and the laser entry tube, preventing the laser-guiding tube from being stuck and unable to move, such that angle and/or position of the laser shock head in relation to the part can be adjusted. The robotic laser-guiding device provided herein uses the manipulator to allow the laser shock head to aim at the position on the part needed to be peened. The reflecting mirrors are configured to change the transmission direction of the laser in the laser-guiding arm, so as to allow the laser to irradiate the part to be processed through the laser shock head.

### BRIEF DESCRIPTION OF THE DRAWINGS

The present disclosure will be further described below with reference to the accompany drawings and embodiments.

FIG. 1 schematically depicts a structure of a robotic laser-guiding device for laser shock peening according to an embodiment of the disclosure;

FIG. 2 schematically depicts guidance of a laser between two adjacent joints according to an embodiment of the disclosure;

FIG. 3 schematically depicts a structure of a laser-guiding arm according to an embodiment of the disclosure; and

FIG. 4 schematically depicts a structure of a laser shock head according to an embodiment of the disclosure.

In the drawings, 100, laser-guiding arm; 110, laser entry tube; 120, laser-guiding tube; 121, first laser-guiding tube; 122, second laser-guiding tube; 123, third laser-guiding tube; 124, connecting tube; 130, laser exit tube; 140, laser shock head; 141, shell; 142, convex lens; 143, fully-transparent plane mirror; 150, joint; 151, first connecting part; 152, second connecting part; 200, reflecting mirror; 300, manipulator; 2000, laser generator; and 2100, output port.

### DETAILED DESCRIPTION OF EMBODIMENTS

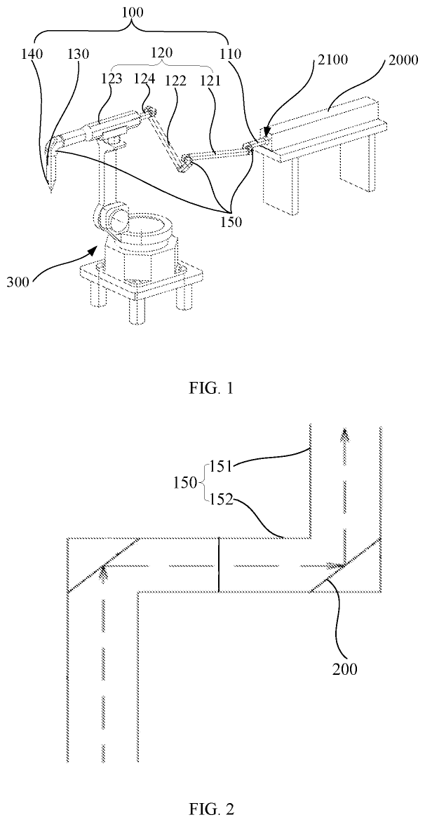

As shown in FIGS. 1-2, a robotic laser-guiding device for laser shock peening includes a laser-guiding arm 100, a reflecting mirror 200 and a manipulator 300 that are sequentially connected. The laser-guiding arm 100 includes a laser entry tube 110, a laser-guiding tube 120, a laser exit tube 130 and a laser shock head 140. The laser-guiding arm 100 also includes a plurality of joints 150. The laser entry tube 110 is rotatably connected to the laser-guiding tube 120 through the plurality of joints 150, and the laser-guiding tube 120 is rotatably connected to the laser exit tube 130 through the plurality of joints 150. The laser entry tube 110 is connected to a laser generator 2000. A plurality reflecting mirrors 200 are provided, and each of the plurality of joints 150 is provided with a reflecting mirror 200. The reflecting mirror 200 is configured to adjust a laser direction. The laser emitted by the laser generator 2000 is capable of passing through the laser entry tube 110, the reflecting mirror 200, the laser-guiding tube 120, the reflecting mirror 200, the laser exit tube 130 and the laser shock head 140 to irradiate a part to be processed, so as to perform laser peening on the part. The laser shock head 140 is configured to focus the laser. The manipulator 300 is connected to the laser-guiding tube 120, and the manipulator 300 is configured to drive the laser-guiding tube 120 to move with respect to the part under a rotation of the joint 150, so as to drive the laser shock head 140 to move with respect to the part through the laser exit tube 130 to adjust an angle between the laser shock head 140 and the part to be processed and/or a position of the laser shock head with respect to the part to be processed.

When it is necessary to perform laser peening on the part to be processed, the manipulator 300 drives the laser-guiding tube 120 to move with respect to the part under the rotation of the joint 150, so as to drive the laser shock head 140 to move with respect to the part through the laser exit tube 130, such that the angle and/or the position of the laser shock head 140 with respect to the part to be processed can be adjusted, and the laser shock head 140 aim at a position on the part that needs to be strengthened by laser peening. The laser emitted by the laser generator 2000 passes through the laser entry tube 110, the reflecting mirror 200, the laser-guiding tube 120, the reflecting mirror 200, the laser exit tube 130 and the laser shock head 140 to irradiate the position on the part to be processed, so as to perform the laser peening on the part. The joint 150 allows the manipulator 300 to drive the laser entry tube 110 to rotate through the joint when the manipulator 300 drives the laser-guiding tube 120 to move, such that the laser-guiding tube 120 and the laser entry tube 110 are rotatable with respect to each other to prevent the laser-guiding tube 120 from being stuck and unable to move. Therefore, the angle and/or position of the laser shock head 140 and the part to be processed can be adjusted. The laser shock head 140 is capable of aiming at the position on the part that needs to be strengthened by the laser peening through a manipulator. The mirror 200 allows the laser to be redirected and transmitted in the laser-guiding arm 100, and finally to be output through the laser shock head 140 to irradiate the part.

Specifically, two components connected by each joint 150 are rotatably connected to the joint 150, and the two components connected by each joint 150 are capable of rotating with respect to the joint.

In an embodiment, the manipulator 300 is capable of swinging, and the manipulator 300 is rotatable around an axis of the manipulator 300, such that the manipulator 300 is capable of driving the laser-guiding tube 120 to move and/or rotate with respect to the part under the rotation of the joint 150 to better adjust the angle and/or the position of the laser shock head 140 with respect to the part to be processed, so as to allow the laser shock head 140 to aim at the part to be processed more reliably.

As shown in FIG. 1, the laser-guiding tube 120 includes a first laser-guiding tube 121, a second laser-guiding tube 122 and a third laser-guiding tube 123 that are sequentially connected. The laser entry tube 110 is connected to an end of the first laser-guiding tube 121 away from the second laser-guiding tube 122. The third laser-guiding tube 123 is connected to an end of the laser exit tube 130 away from the laser shock head 140. The laser entry tube 110 is rotatably connected to the first laser-guiding tube 121 through the joint 150. The first laser-guiding tube 121 is rotatably connected to the second laser-guiding tube 122 through the joint 15. The second laser-guiding tube 122 is rotatably connected to the third laser-guiding tube 123 through the joint 15. The third laser-guiding tube 123 is rotatably connected to the laser exit tube 130 through the joint 15. The manipulator 300 is connected to the third laser-guiding tube 123. The manipulator 300 is configured to drive the third laser-guiding tube 123 to move with respect to the part under the rotation of the joint 150, so as to drive the laser shock head 140 to move with respect to the part through the laser exit tube 130, such that the angle and/or the position of the laser shock head 140 with respect to the part to be processed can be adjusted. When the manipulator 300 drives the laser-guiding tube 120 to move with respect to the part to be processed under the rotation of the joint 150, through the joint 150, the laser entry tube 110 is movable with respect to the first laser-guiding tube 121; the first laser-guiding tube 121 is movable with respect to the second laser-guiding tube 122; and the second laser-guiding tube 122 is movable with respect to the third laser-guiding tube 123 so as to prevent the third laser-guiding tube 123 from being stuck and unable to move.

In this embodiment, the laser emitted by the laser generator 2000 is capable of sequentially passing through the laser entry tube 110, the reflecting mirror 200, the first laser-guiding tube 121, the reflecting mirror 200, the second laser-guiding tube 122, the reflecting mirror 200, the third laser-guiding tube 123, the laser reflector 200, the laser exit tube 130 and the laser shock head 140 to irradiate the part to be processed, so as to perform the laser peening on the part.

In some embodiments, the number of the first laser-guiding tube 121 and/or the second laser-guiding tube 122 is adjustable. Specifically, the number of the first laser-guiding tube 121 and/or the second laser-guiding tube 122 is adjusted according to a distance for transmitting the laser and complexity of components. When the distance for transmitting the laser is small and the complexity of the components is low, the number of the first laser-guiding tube 121 and/or the second laser-guiding tube 122 is reduced, even to zero. When the distance for transmitting the laser is large and the complexity of the components are high, the number of the first laser-guiding tube 121 and/or the second laser-guiding tube 122 is increased.

Specifically, the third laser-guiding tube 123 is connected to the manipulator 300, and the manipulator 300 is configured to drive the laser-guiding tube 120 to move with respect to the part to be processed, such that the angle and/or the position between the laser shock head 140 and the part to be processed can be adjusted. In addition, the laser-guiding tube 123 is part of the laser-guiding arm 100, and is configured for laser guide of back part of the device provided herein.

As shown in FIG. 1, the laser-guiding tube 120 further includes a connecting tube 124. The connecting tube 124 is arranged between the second laser-guiding tube 122 and the third laser-guiding tube 123. The second laser-guiding tube 122 is rotatably connected to the connecting tube 124 through the joint 150.

Referring to FIGS. 1-2, in this embodiment, the laser emitted by the laser generator 2000 is capable of sequentially passing through the laser entry tube 110, the reflecting mirror 200, the first laser-guiding tube 121, the reflecting mirror 200, the second laser-guiding tube 122, the reflecting mirror 200, the third laser-guiding tube 123, the connecting tube 124, the reflecting mirror 200, the laser exit tube 130 and the laser shock head 140 to irradiated on the part to be processed, so as to perform the laser peening on the part.

In some embodiments, the third laser-guiding tube 123 is detachably connected to the connecting tube 124.

In some embodiments, the third laser-guiding tube 123 is threadedly connected to the connecting tube 124, so as to facilitate the disassembly between the third laser-guiding tube 123 and the connecting tube 124.

As shown in FIG. 1, the third laser-guiding tube 123 and the connection tube 124 are coaxially arranged to facilitate the laser transmission between the connection tube 124 and the third laser-guiding tube 123.

As shown in FIG. 2, the joint 150 includes a first connecting part 151 and a second connecting part 152, and the first connecting part 151 is perpendicularly connected to the second connecting part 152. The first connecting part 151 and the second connecting part 152 are respectively connected to two components connected by the same joint 150, such that axes of the two components connected by the same joint 150 are perpendicular to each other. Specifically, the component connected to the first connecting part 151 is rotatable with respect to the first connecting part 151, and the component connected to the second connecting part 152 is rotatable with respect to the second connecting part 152.

As shown in FIG. 2, an angle between each reflecting mirror 200 and the laser irradiated thereon is 45°, such that a travelling direction of the laser is changed by 90° at each joint 150.

In some embodiments, the reflecting mirror 200 is made of a copper material, which has fast heat dissipation.

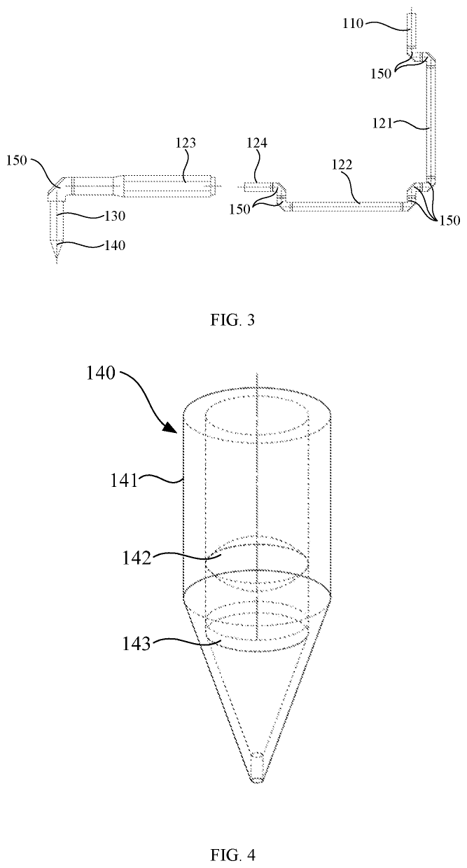

As shown in FIGS. 1 and 3, the laser entry tube 110 is rotatably connected to the first laser-guiding tube 121 through the plurality of joints 150; the first laser-guiding tube 121 is rotatably connected to the second laser-guiding tube 122 through the plurality of joints; and the second laser-guiding tube 122 is rotatably connected to the third laser-guiding tube 123 through the plurality of joints 150. Two adjacent joints 150 of the plurality of joints 150 are rotatably connected to each other. Specifically, due to such arrangement of the plurality of joints 150, more degrees of freedom of rotation are achieved between the laser entry tube 110 and the first laser-guiding tube 121, between the first laser-guiding tube 121 and the second laser-guiding tube 122, and between the second laser-guiding tube 122 and the third laser-guiding tube 123.

In some embodiments, a connection between the joint 150 and each component is provided with a swivel bearing, and each component is rotatable with respect to the joint through the swivel bearing.

As shown in FIGS. 1 and 3, the laser entry tube 110 is rotatably connected to the first laser-guiding tube 121 through two joints 150. The second laser-guiding tube 122 is rotatably connected to the third laser-guiding tube 123 through two joints 150. The first laser-guiding tube 121 is rotatably connected to the second laser-guiding tube 122 through three joints.

A return spring is provided between the two joints 150 that are arranged between the laser entry tube 110 and the first laser-guiding tube 121. A return spring is provided between the two joints 150 that are arranged between the second laser-guiding tube 122 and the third laser-guiding tube 123. Specifically, due to such arrangement of the return spring, the return springs receive a torsion force when the laser-guiding arm 100 is transformed from an initial state to a working state; and when the laser-guiding arm 100 is transformed from the working state to the initial state, torsion of the return springs resets the two joints 150 between the laser entry tube 110 and the first laser-guiding tube 121 and the two joints 150 between the second laser-guiding tube 122 and the third laser-guiding tube 123.

As shown in FIG. 1, the laser generator 2000 is provided with an output port 2100. The laser generator 2000 is configured to output the laser through the output port 2100. The laser entry tube 110 is connected to the output port 2100 of the laser generator 2000, and the laser entry tube 110 and the output port 2100 are coaxially arranged. Specifically, the laser is output along an axis of the output port 2100 and is transmitted along an axis of the laser entry tube 110.

Further, the laser entry tube 110, the first laser-guiding tube 121, the second laser-guiding tube 122, the third laser-guiding tube 123, the laser exit tube 130, and the laser shock head 140 are all hollow. The laser is transmitted along an axial of each component of the laser-guiding arm 100.

Since the laser generator 2000 and the laser-guiding arm 100 are linked, no matter how the manipulator 300 drives the third laser-guiding tube 123 of the laser-guiding arm 100 to move, the laser emitted by the laser generator 2000 will enter the laser-guiding arm 100 along the output port 2100 of the of the laser generator 2000, transmit through the laser-guiding arm 100, and then exit through guided transmission of the laser-guiding arm. In this way, the laser peening is easy to control.

The laser shock head 140 is detachably connected to the laser exit tube 130. Specifically, when being damaged, the laser shock head 140 can be directly removed from the laser exit tube 130 for replacement. In addition, the laser shock head 140 of different specifications can be directly replaced according to actual needs.

In some embodiments, the laser shock head 140 is threadedly connected to the laser exit tube 130, so as to facilitate the disassembly of the laser shock head 140 from the laser exit tube 130.

As shown in FIGS. 1 and 4, the laser shock head 140 includes a shell 141, a convex lens 142 and a fully-transparent plane mirror 143. The convex lens 142 is arranged in the shell 141. One end of the shell 141 is connected to the laser exit tube 130, and the other end of the shell 141 is provided with the fully-transparent plane mirror 143. The convex lens 142 is configured to focus the laser. The fully-transparent plane mirror 143 is configured to block an external interference object from being contact with the convex lens 142. The laser output by the laser exit tube is capable of passing through a first open end of the shell 141 to enter the shell 141, and sequentially passing through the convex lens 142, the fully-transparent plane mirror 143 and a second open end of the housing 141 to be transmitted to an outside of the shell 141. Specifically, the fully-transparent plane mirror 143 is configured to block external dust or water from splashing on a surface of the convex lens 142.

What is claimed is:

1. A robotic laser-guiding device for laser shock peening, comprising:
a laser-guiding arm;
a first reflecting mirror;
a second reflecting mirror; and
a manipulator;
wherein the laser-guiding arm comprises a laser entry tube, a laser-guiding tube, a laser exit tube and a laser shock head; the laser entry tube, the laser-guiding tube, the laser exit tube and the laser shock head are sequentially connected; the laser-guiding arm also comprises a first joint and a second joint; the laser entry tube is rotatably connected to the laser-guiding tube through the first joint; the laser-guiding tube is rotatably connected to the laser exit tube through the second joint; and the laser entry tube is connected to a laser generator;
the first reflecting mirror is provided in the first joint; the second reflecting mirror is provided in the second joint; the first reflecting mirror and the second reflecting mirror are configured to adjust a direction of laser; the laser emitted by the laser generator is configured to pass through the laser entry tube, the first reflecting mirror, the laser-guiding tube, the second reflecting mirror, the laser exit tube and the laser shock head to irradiate a part to be processed, so as to perform laser shock peening on the part to be processed; and the laser shock head is configured to focus the laser; and
the manipulator is connected to the laser-guiding tube; the manipulator is configured to drive the laser-guiding tube to move with respect to the part to be processed under a rotation of the first joint and the second joint, so as to drive the laser shock head to move with respect to the part to be processed through the laser exit tube to adjust an angle and/or a position of the laser shock head with respect to the part to be processed.

2. The robotic laser-guiding device of claim 1, wherein the laser-guiding tube comprises a first laser-guiding tube, a second laser-guiding tube and a third laser-guiding tube; the first laser-guiding tube, the second laser-guiding tube and the third laser-guiding tube are sequentially connected; the laser entry tube is connected to an end of the first laser-guiding tube away from the second laser-guiding tube; the third laser-guiding tube is connected to an end of the laser exit tube away from the laser shock head; the laser entry tube is rotatably connected to the first laser-guiding tube through the first joint; the first laser-guiding tube is rotatably connected to the second laser-guiding tube through a third joint; the second laser-guiding tube is rotatably connected to the third laser-guiding tube through a fourth joint; the third laser-guiding tube is rotatably connected to the laser exit tube through the second joint;
a third reflecting mirror is provided in the third joint; a fourth reflecting mirror is provided in the fourth joint; the manipulator is connected to the third laser-guiding tube; the manipulator is configured to drive the third laser-guiding tube to move with respect to the part to be processed under rotation of the first joint, the second joint, the third joint and the fourth joint, so as to drive the laser shock head to move with respect to the part to be processed through the laser exit tube to adjust the angle and/or the position of the laser shock head with respect to the part to be processed.

3. The robotic laser-guiding device of claim 2, wherein the laser-guiding tube further comprises a connecting tube; the connecting tube is arranged between the second laser-guiding tube and the third laser-guiding tube; and the second laser-guiding tube is connected to the connecting tube through the fourth joint.

4. The robotic laser-guiding device of claim 2, wherein the first joint, the second joint, the third joint and the fourth joint each comprises a first connecting part and a second connecting part; the first connecting part and the second connecting part are perpendicularly connected; and the first connecting part and the second connecting part are respectively connected to two components that are connected through one of the first joint, the second joint, the third joint and the fourth joint.

5. The robotic laser-guiding device of claim 4, wherein an angle between each reflecting mirror and the laser irradiated thereon is 45°, such that after reflected by each reflecting mirror, a travelling direction of the laser is changed by 90° at each joint.

6. The robotic laser-guiding device of claim 2, wherein the first joint comprises a plurality of first joints; the third joint comprises a plurality of third joints; the fourth joint comprises a plurality of fourth joints; two adjacent first joints are rotatably connected to each other; two adjacent third joints are rotatably connected to each other; and two adjacent fourth joints are rotatably connected to each other.

7. The robotic laser-guiding device of claim 6, wherein the number of the plurality of first joints is two; the number of the plurality of fourth joints is two; and
the number of the third joints is three.

8. The robotic laser-guiding device of claim 1, wherein the laser generator is provided with an output port; the laser generator is configured to output the laser through the output port; the laser entry tube is connected to the output port of the laser generator; and the laser entry tube and the output port are coaxially arranged.

9. The robotic laser-guiding device of claim 1, wherein the laser shock head is detachably connected to the laser exit tube.

10. The robotic laser-guiding device of claim 1, wherein the laser shock head comprises a shell, a convex lens and a fully-transparent plane mirror; the shell is hollow; two ends of the shell are open; a first open end of the shell is connected to the laser exit tube; a second open end of the shell is provided with the fully-transparent plane mirror; the convex lens is arranged in the shell; the convex lens is configured to focus the laser; the fully-transparent plane mirror is configured to block an external interference object from being contact with the convex lens; the laser output through the laser exit tube is capable of passing through the first open end of the shell to enter the shell and sequentially passing through the convex lens, the fully-transparent plane mirror and the second open end of the shell to be transmitted to an outside of the shell.
